(19) United States
(12) Patent Application Publication
(10) Pub. No.: US 2008/0045410 A1
(43) Pub. Date: Feb. 21, 2008

(54) HIGHLY PHOTOCATALYTIC PHOSPHORUS-DOPED ANATASE-TiO2 COMPOSITION AND RELATED MANUFACTURING METHODS

(76) Inventors: Jan Prochazka, Zehrovice (CZ); Timothy Spitler, Fernley, NV (US)

Correspondence Address: SHEPPARD MULLIN RICHTER & HAMPTON LLP, 48th Floor, 333 South Hope Street, Los Angeles, CA, 90071, US

(21) Appl. No.: 11/466,699

(22) Filed: Aug. 23, 2006

Related U.S. Application Data
(60) Provisional application No. 60/710,381, filed on Aug. 23, 2005.

(51) Int. Cl. B01J 27/14

(52) U.S. Cl. 502/208

(57) ABSTRACT

The present invention is generally directed to doped anatase-TiO₂ compositions that exhibit enhanced photocatalytic activity. In a composition aspect, the present invention provides a nanosized, anatase crystalline titanium dioxide composition. The composition is doped with phosphorus, and the doping level is between 0.10 and 0.55 weight percent.

### CROSS-REFERENCE TO RELATED APPLICATION

This application claims priority to U.S. Provisional Patent Application Ser. No. 60/710,381 filed on Aug. 23, 2005, the entire disclosure of which is incorporated by reference.

### FIELD OF THE INVENTION

The present invention is generally directed to doped anatase-TiO₂ compositions that exhibit enhanced photocatalytic activity.

### BACKGROUND OF THE INVENTION

For many years, the pigment industry focused on reducing the photocatalytic activity of TiO₂, since it caused degradation of organic resins and the chalking of a painted surface. With the discovery of high surface area TiO₂ nanomaterials, however, some scientists have focused on understanding and even maximizing the photocatalytic behavior of titanium dioxide. Such efforts have oftentimes been directed to the development of materials that catalyze the photodecomposition of low concentrations of organic pollutants in air and water.

Nanosized anatase TiO₂ has been examined as a photocatalyst. As the anatase band gap of 3.2 eV is close to the decomposition of water, a primary focus has been on modifying this band gap through lattice and surface doping. To date, though, there has not been a systematic study on the correlation between dopants and exact effect. Moreover, the preparation of a substantial number of the doped materials has occurred through inconsistent methodology, which makes the comparison of reported studies very difficult.

In reported doping studies, Degussa P25 is a relatively consistent and commercially available product that has become a virtual photocatalytic standard. This is the case even though Degussa P25 is not a phase pure anatase, and the content of rutile is variable.

It is generally accepted in that art that phosphorus doping lowers the catalytic activity of materials such as Degussa P25. The present invention refutes this theory through the presentation of an unexpected and beneficial finding.

### SUMMARY OF THE INVENTION

The present invention is generally directed to doped anatase-TiO₂ compositions that exhibit enhanced photocatalytic activity.

In a composition aspect, the present invention provides a nanosized, anatase crystalline titanium dioxide composition. The composition is doped with phosphorus, and the doping level is between 0.10 and 0.55 weight percent.

In a method aspect, the present invention provides a method of making a phosphorus-doped, anatase crystalline titanium dioxide. The comprises the steps of: 1) spray drying of a phosphorus-doped solution of titanium oxychloride, titanium oxysulphate or aqueous solution of another titanium salt to produce an amorphous titanium dioxide solid intermediate with homogeneously distributed atoms of phosphorus through the matter, wherein the amount of phosphorus in the solution is selected to produce a material doped to the extent of 0.10 and 0.55 weight percent; and, 2) calcining the amorphous, solid intermediate at a temperature between 300 and 900° C.

In another method aspect, the present invention provides a method of inducing the photodecomposition of an organic compound. The method involves exposing the organic compound to a phosphorus-doped, anatase, crystalline titanium dioxide material in the presence of light. The photocatalytic activity of the phosphorus-doped material is at least 100 percent greater than the undoped material.

### BRIEF DESCRIPTION OF THE FIGURES

FIG. 1 shows a graph of relative photocatalytic degradation of 4-CP on the surface of phosphorus-doped anatase materials in relation to 4-CP degradation on TiO₂ standard Degussa P25.

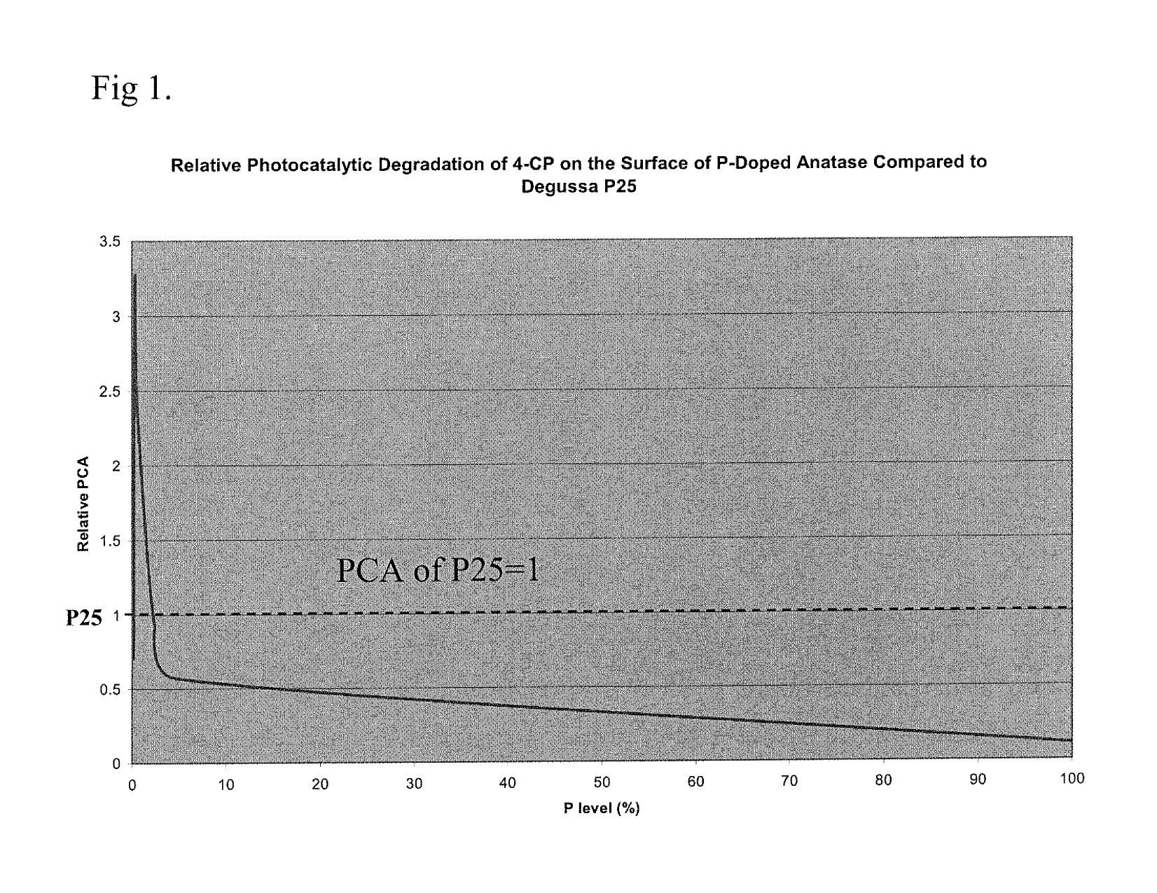

FIG. 2 shows a section on the graph of FIG. 1, where phosphorus doping significantly accelerated the overall photocatalytic decomposition of 4-CP. Data are relative to the degradation of 4-CP on the surface of TiO₂ standard Degussa P25.

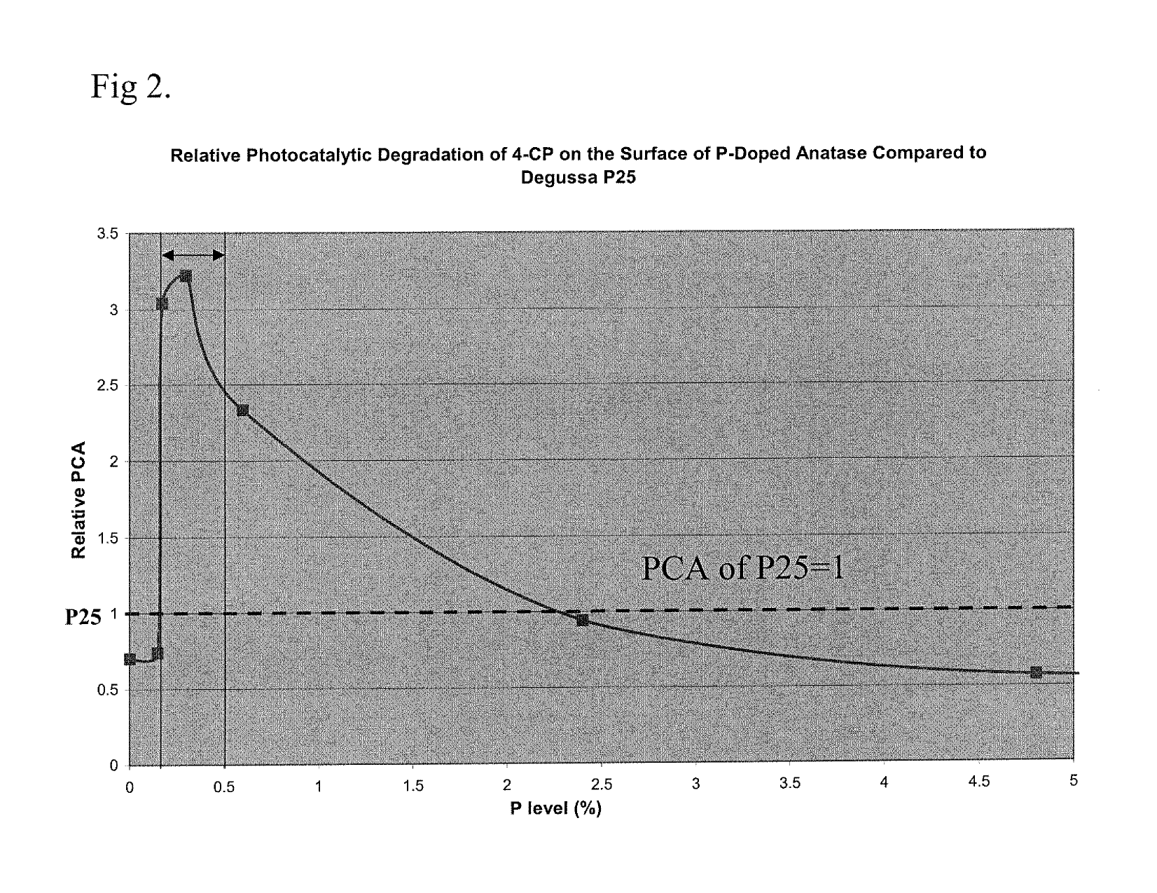

FIG. 3 shows an ORD pattern of titanium pyrophosphate—TiP₂O₇—which is one of the compounds that may be created “in situ” on the surface of anatase nanoparticle.

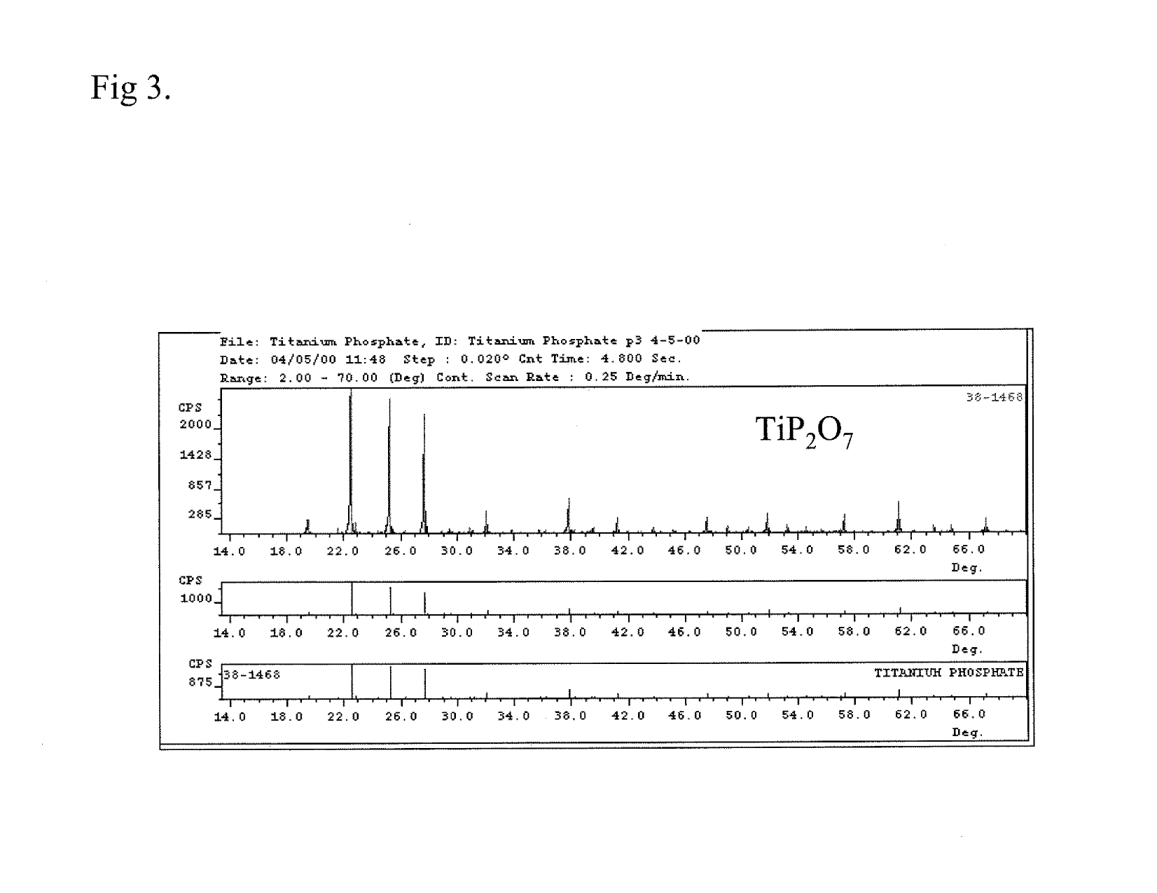

FIG. 4 shows SEM pictures of 0.3% Phosphorus-doped nano-anatase.

FIG. 5 shows a comparison of photodegradation rate constants of 4-chlorophenol and isopropanol on undoped and 0.3% Phosphorus-doped anatase and Degussa P25 standard analyzed by HPLC and TOC (total organic carbon) method.

FIG. 6 shows a comparison of photodegradation of 4-chlorophenol on undoped and 0.3% Phosphorus-doped anatase, including the intermediate organic products of the decomposition, analyzed by HPLC.

FIG. 7 shows a comparison of photodegradation of 4-chlorophenol on 0.3% Phosphorus-doped anatase and Degussa P25 analyzed by TOC method.

FIG. 8 shows photodegradation of 4-chlorophenol on 2.4% Phosphorus-doped anatase including the intermediate products of the degradation determined by the HPLC measurement method.

### DETAILED DESCRIPTION OF THE INVENTION

The present invention describes an effective phosphorus doping level in nanosized, anatase, crystalline titanium dioxide. The doping increases the photodegradation of organic compounds on the surface of doped TiO₂ several times as compared to undoped TiO₂.

Typically, the doping level of phosphorus in the TiO₂ is between 0.10 and 0.55 weight percent. Preferably, the doping level is between 0.15 and 0.50 weight percent or 0.20 and 0.40 weight percent. More preferably, the doping level is between 0.25 and 0.35 weight percent or 0.27 and 0.33 weight percent, with about 0.30 weight percent being optimal.

Without being bound by any theory, applicants currently believe the following to be a plausible explanation of the observed doping effects. Phosphorus does generally lower the photocatalytic activity of anatase. Its presence, however, significantly increases the adsorption of organic compounds on the surface of the nanoanatase. This makes the overall photodegradation process more effective.

Phosphorus has a limited solubility in the anatase lattice. In a calcination step, excess phosphorus is driven out from the lattice and ends up on the particle surface. Rejection of the phosphorus by the lattice is a relatively complicated process and proper deposition of the titanium pyrophosphate on the particle is a state of the art procedure. Depending on the calcination temperature, titanium phosphate, titanyl phosphate, titanium pyrophosphate or their mixtures form on the particle surface.

Excess phosphorus creates a thin layer on the nanoanatase particle. This may explain photodegradation acceleration: Low concentrations of phosphorus are evenly distributed throughout the anatase crystal lattice and accordingly will not impact absorption properties of the material. At a certain phosphorus concentration, a monomolecular layer of titanium phosphate is formed on the particle surface. This significantly increases the adsorption of organic compounds and accelerates the photodegradation process. Further increasing phosphorus levels induces the formation of a compact, thicker layer of titanium phosphate or pyrophosphate. The adsorption of organic compounds of the particle surface is concomitantly increased, but the photoactive TiO₂ core is insulated from the compounds; activity is accordingly decreased.

Data shoe that adsorption of n-butanol on the surface of 1.2% P-doped anatase can be twice as high as adsorption on an undoped surface. The n-butanol adsorption does not further significantly increase at higher phosphorus levels.

The most effective range of phosphorus doped nanoanatase may be conveniently manufactured by spray drying of a phosphorus-doped solution of titanium oxychloride, titanium oxysulphate or aqueous solution of another titanium salt to produce an amorphous titanium dioxide solid intermediate with homogeneously distributed atoms of phosphorus through the matter. The amorphous solid intermediate is then calcined in the next step to produce crystalline particles of phosphorus-doped anatase (300-900° C.). The calcined material can be optionally milled to produce dispersed anatase particles.

Typically, the doping increases the photodegradation of organic compounds on the surface of doped TiO₂ at least 100 percent as compared to undoped TiO₂. Oftentimes, the doping increases photodegradation at least 150 or 200 percent. In certain cases, the doping increases photodegradation at least 250 or 300 percent.

### EXAMPLES

### Example 1

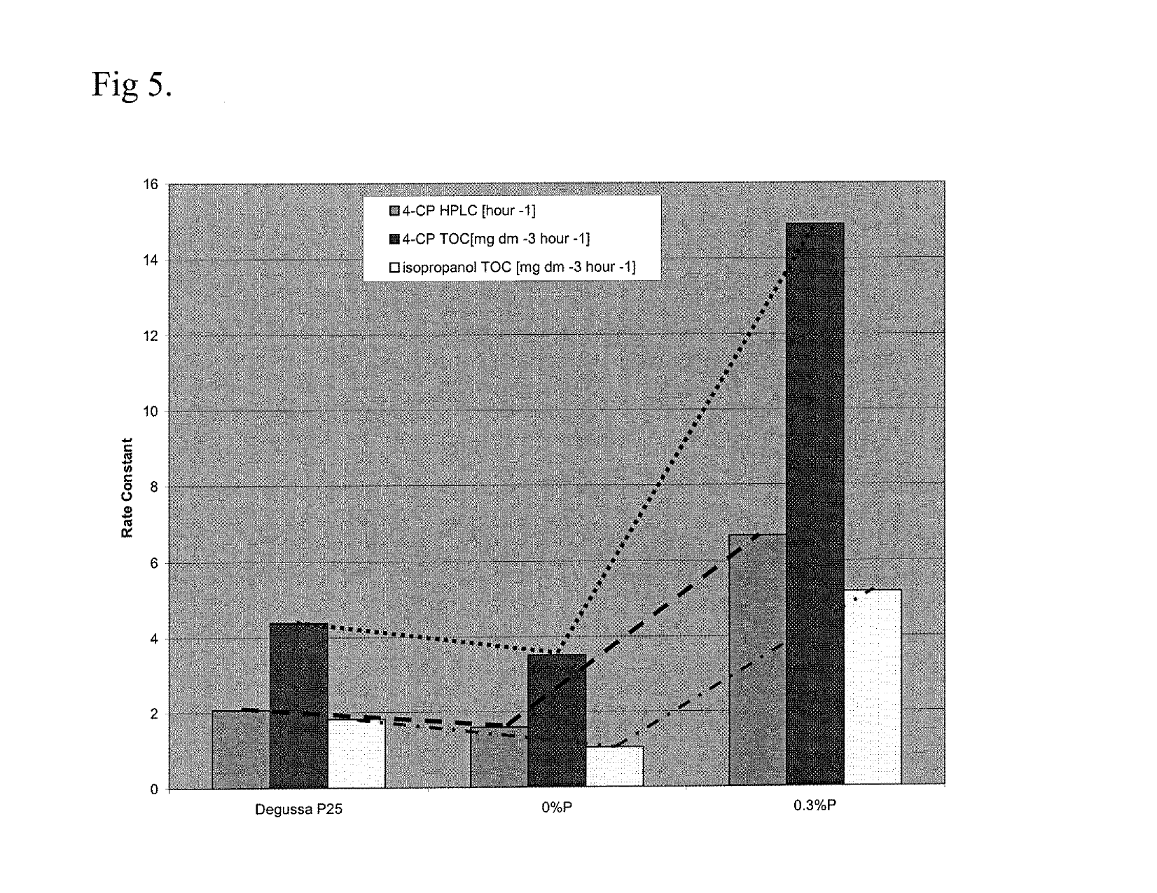

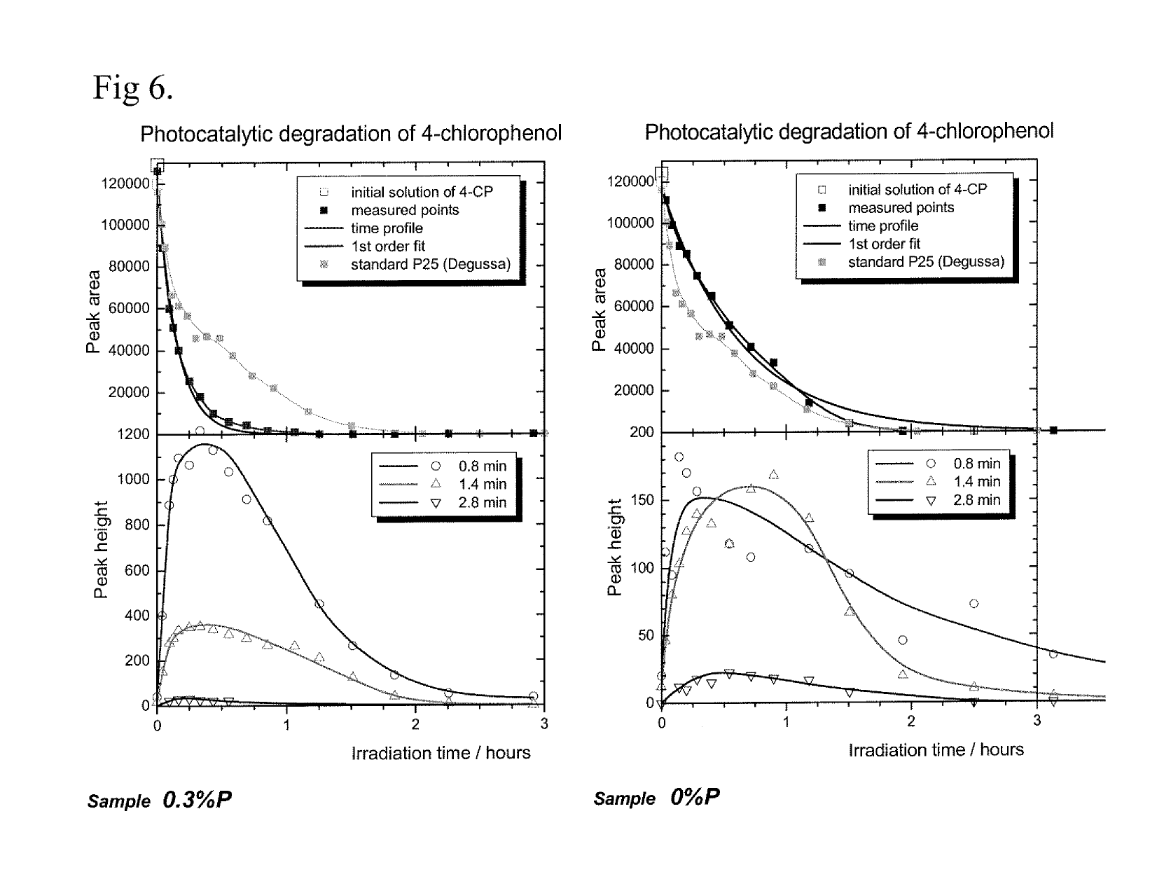

Titanium oxychloride solution (120 g Ti/L) was spray dried at 250° C. to produce an intermediate that was further calcined at 550° C. for 24 hours. Primary particles obtained in the calcinations were about 40 nm in size. The particles were organized in a hollow sphere thin film macrostructure. The product was further dispersed to the primary particles. Photocatalytic mineralization of organic compounds on this product was about the same as on the commercial TiO₂ standard Degussa P25 (FIG. 5 and FIG. 6).

### Example 2

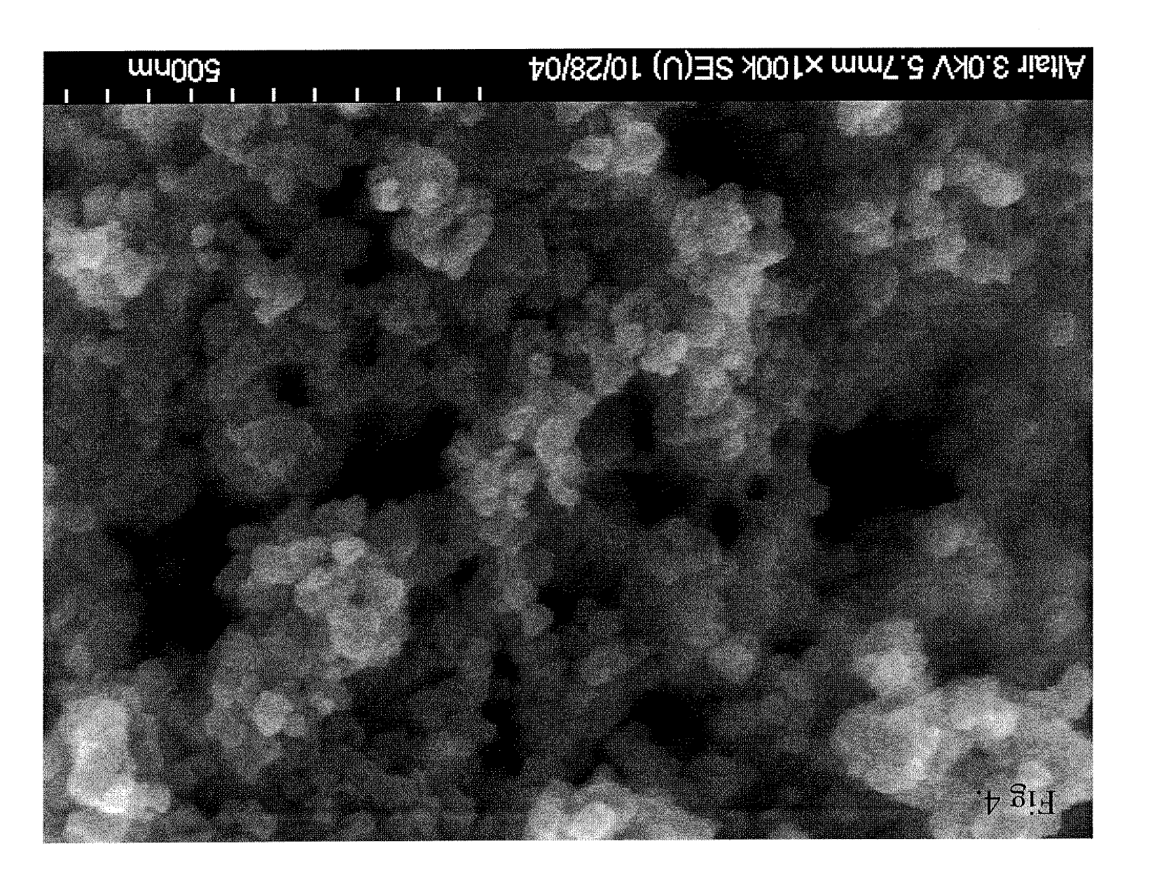

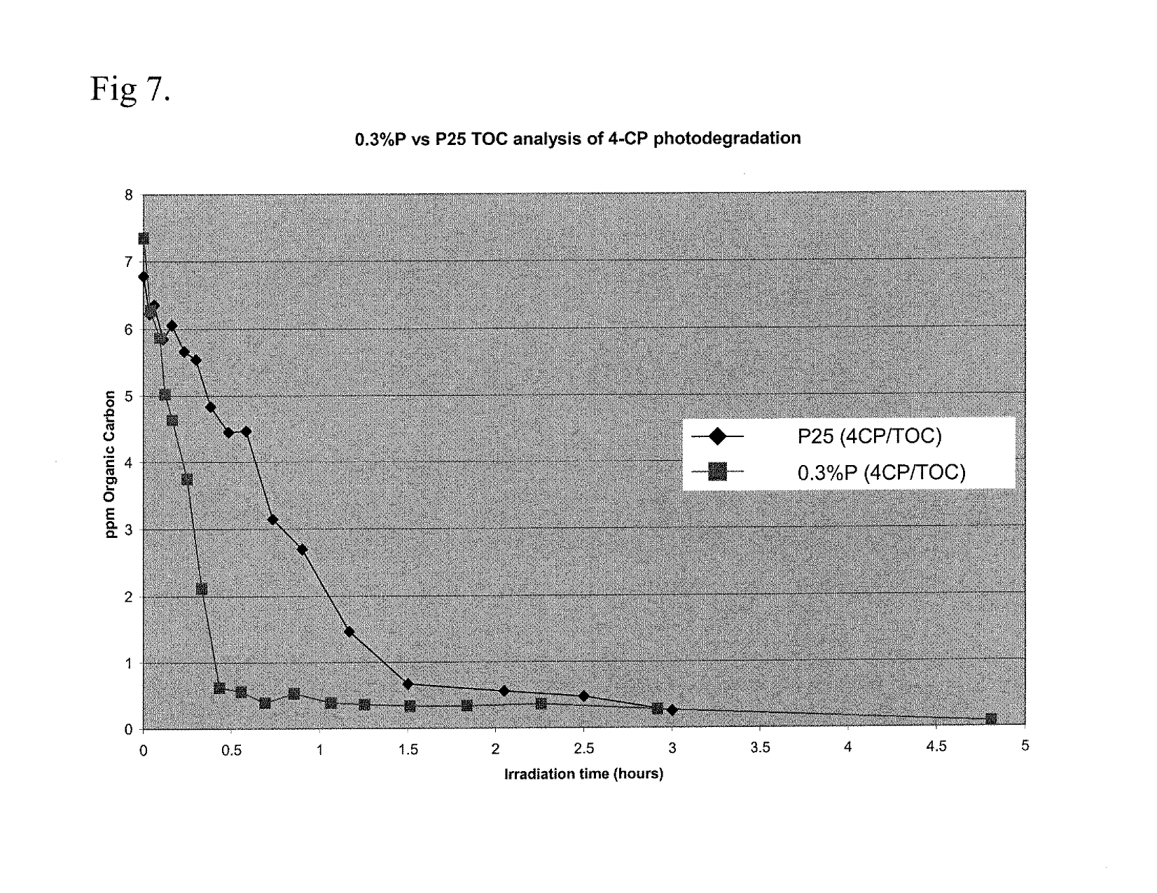

Titanium oxychloride solution (120 g Ti/L) was treated with an amount of phosphoric acid equal to 0.3 wt % of phosphorus in TiO₂. The solution was spray dried at 250° C. to produce a solid intermediate that was further calcined at 750° C. for 16 hours. Primary particles obtained in the calcinations were about 40 nm in size. The particles were organized in a hollow sphere thin film macrostructure. The product was further dispersed to the primary particles (FIG. 4). Photocatalytic degradation of organic compounds on this product was about three times faster than on the commercial TiO₂ standard Degussa P25 (FIGS. 5, 6 and 7). Absorption of n-BOH on the surface of this product was about two times higher than on Degussa P25.

### Example 3

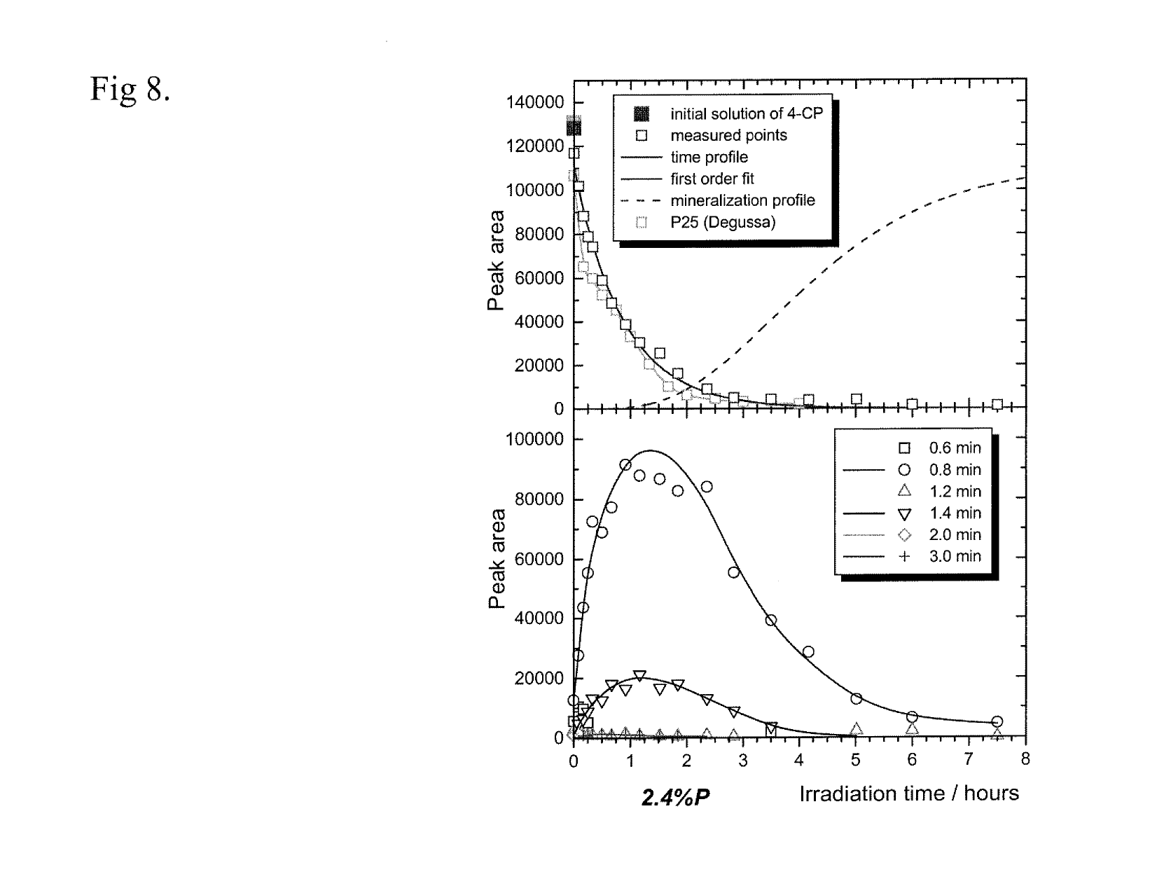

Titanium oxychloride solution (130 g Ti/L) was treated with an amount of phosphoric acid equal to 2.4 wt % of phosphorus in TiO₂. The solution was spray dried at 250° C. to produce an intermediate that was further calcined at 800° C. for 16 hours. Primary particles obtained in the calcinations were about 40 nm in size. The particles were organized in a hollow sphere thin film macrostructure. The product was further dispersed to the primary particles. Photocatalytic mineralization of organic compounds on this product was significantly slower than on the commercial TiO2 standard Degussa P25. In addition, many organic decomposition intermediate products were formed during the photodegradation (FIG. 8).

### Example 4

Titanium oxychloride solution (120 g Ti/L) was treated with an amount of phosphoric acid equal to 0.3 wt % of phosphorus in TiO₂. The solution was spray dried at 250° C. to produce a solid intermediate that was further calcined at 750° C. for 16 hours. Primary particles obtained in the calcinations were about 40 nm in size. The particles were organized in a hollow sphere thin film macrostructure. Photocatalytic degradation of organic compounds on this product was about three times faster than on the commercial TiO₂ standard Degussa P25 and slightly faster than on 0.3% P material, the surface of which was damaged by mechanical milling operations. Because of easy separation of this material in heterogeneous systems, this material is thought to be the optimal photocatalyst for applications, where unmounted TiO₂ compound is used.

1. A nanosized, anatase crystalline titanium dioxide composition, wherein the composition is doped with phosphorus, and wherein the doping level is between 0.10 and 0.55 weight percent.

2. The composition according to claim 1, wherein the doping level is between 0.15 and 0.50 weight percent.

3. The composition according to claim 2, wherein the doping level is between 0.20 and 0.40 weight percent.

4. The composition according to claim 3, wherein the doping level is between 0.25 and 0.35 weight percent.

5. The composition according to claim 4, wherein the doping level is between 0.27 and 0.33 weight percent.

6. A method of making a phosphorus-doped, anatase crystalline titanium dioxide, wherein the method comprises the steps of:
a) spray drying of a phosphorus-doped solution of titanium oxychloride, titanium oxysulphate or aqueous solution of another titanium salt to produce an amorphous titanium dioxide solid intermediate with homogeneously distributed atoms of phosphorus through the matter, wherein the amount of phosphorus in the solution is selected to produce a material doped to the extent of 0.10 and 0.55 weight percent; and,
b) calcining the amorphous, solid intermediate at a temperature between 300 and 900° C.
thereby producing the crystalline titanium dioxide.

7. The method according to claim 6, wherein the amount of phosphorus in the solution is selected to produce a material doped to the extent of 0.15 and 0.50 weight percent.

8. The method according to claim 7, wherein the amount of phosphorus in the solution is selected to produce a material doped to the extent of 0.20 and 0.40 weight percent.

9. The method according to claim 8, wherein the amount of phosphorus in the solution is selected to produce a material doped to the extent of 0.25 and 0.35 weight percent.

10. The method according to claim 9, wherein the amount of phosphorus in the solution is selected to produce a material doped to the extent of 0.27 and 0.33 weight percent.

11. A method of inducing the photodecomposition of an organic compound, wherein the method comprises the step of exposing the organic compound to a phosphorus-doped, anatase, crystalline titanium dioxide material in the presence of light, wherein the photocatalytic activity of the phosphorus-doped material is at least 100 percent greater than the undoped material.

12. The method according to claim 11, wherein the photocatalytic activity of the phosphorus-doped material is at least 150 percent greater than the undoped material.

13. The method according to claim 11, wherein the photocatalytic activity of the phosphorus-doped material is at least 200 percent greater than the undoped material.

14. The method according to claim 11, wherein the photocatalytic activity of the phosphorus-doped material is at least 250 percent greater than the undoped material.

15. The method according to claim 11, wherein the photocatalytic activity of the phosphorus-doped material is at least 300 percent greater than the undoped material.
